(19) United States
(12) Patent Application Publication
(10) Pub. No.: US 2010/0154015 A1
(43) Pub. Date: Jun. 17, 2010

(54) METADATA SEARCH APPARATUS AND METHOD USING SPEECH RECOGNITION, AND IPTV RECEIVING APPARATUS USING THE SAME

(75) Inventors: Byung Ok KANG, Daejeon (KR); Eui Sok CHUNG, Daejeon (KR); Ji Hyun WANG, Daejeon (KR); Yun Keun LEE, Daejeon (KR); Jeom Ja KANG, Daejeon (KR); Jong Jin KIM, Daejeon (KR); Ki-young PARK, Daejeon (KR); Jeon Gue PARK, Daejeon (KR); Sung Joo LEE, Daejeon (KR); Hyung-Bae JEON, Daejeon (KR); Ho-Young JUNG, Daejeon (KR); Hoon CHUNG, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/437,261

(22) Filed: May 7, 2009

(30) Foreign Application Priority Data
Dec. 11, 2008 (KR) 10-2008-0125621

(51) Int. Cl. H04N 7/173; G10L 15/04; G06F 17/30

(52) U.S. Cl. 725/110; 704/251; 704/E15.005; 707/E17.014; 707/E17.015

(57) ABSTRACT

A metadata search apparatus using speech recognition includes a metadata processor for processing contents metadata to obtain allomorph of target vocabulary required for speech recognition and search; a metadata storage unit for storing the contents metadata; a speech recognizer for performing speech recognition on speech data uttered by a user by searching the allomorph of the target vocabulary; a query language processor for extracting a keyword from the vocabulary speech-recognized by the speech recognizer; and a search processor for searching the metadata storage unit to extract the contents metadata corresponding to the keyword. An IPTV receiving apparatus employs the metadata search apparatus to provide IPTV services through the functions of speech recognition.

### CROSS-REFERENCE(S) TO RELATED APPLICATION(S)

The present invention claims priority of Korean Patent Application No. 10-2008-0125621, filed on Dec. 11, 2008, which is incorporated herein by reference.

### FIELD OF THE INVENTION

The present invention relates to an Internet protocol television (IPTV) using a speech interface, and more particularly, to an apparatus and method for searching for VOD contents by using allomorph of the VOD contents corresponding to uttered speech data that is speech-recognized through a speech interface, and an IPTV receiving apparatus for providing IPTV services using the same.

### BACKGROUND OF THE INVENTION

As well-known in the art, an IPTV service refers to a service which transmits various contents such as information, movies, broadcasting, and so on over the Internet so as to provide them through TVs.

For use of IPTV, it is necessary to equip a set-top box connected to the Internet along with TV. IPTV is known as one type of digital convergences in that it is a combination of the Internet and TV. When comparing with the existing Internet TV, IPTV employs a TV in place of a computer and a remote controller in place of a mouse. Therefore, even users who are unfamiliar with their computers can not only perform Internet search simply by using a remote controller, but also receive various contents and additional services, such as movie watching, home shopping, online games and so on, provided by the Internet.

In addition, IPTV is similar to the general cable broadcasting or satellite broadcasting in that it provides broadcast contents including videos, but is characterized by further adding interactivity thereto. Unlike the general over-the-air-broadcasting, cable broadcasting and satellite broadcasting, viewers of the IPTV can watch only their desired programs at their convenient times. Moreover, the use of such interactivity enables the derivation of diverse types of services.

A typical IPTV service allows a user to receive diverse contents such as VOD or other services provided by clicking a designated button on a remote controller. Differently from a computer with various user interfaces such as keyboard, mouse, etc., IPTV has no particular user interface to date, except for a remote controller. This is because the types of services offered by IPTV are still limited and only services that are dependent on the remote controller are provided. Therefore, it will be obvious to those skilled in the art that, if more various services are to be provided in the future, the remote controller will have the limit as the interface. In particular, for VOD services, the user has to continuously click certain buttons on the remote controller or to input corresponding ones on the keypad for searching a desired VOD title from among a great number of VOD titles.

### SUMMARY OF THE INVENTION

The present invention is made in view of the foregoing shortcomings, therefore, the present invention provides a metadata search apparatus and method using a speech interface, and an IPTV receiving apparatus using the same.

In accordance with a first aspect of the present, there is provided a metadata search apparatus using speech recognition, including: a metadata processor for processing contents metadata to obtain allomorph of target vocabulary required for speech recognition and search; a metadata storage unit for storing the contents metadata; a speech recognizer for performing speech recognition on speech data uttered by a user by searching the allomorph of the target vocabulary; a query language processor for extracting a keyword from the vocabulary speech-recognized by the speech recognizer; and a search processor for searching the metadata storage unit to extract the contents metadata corresponding to the keyword.

In accordance with a second aspect of the present, there is provided a metadata search method using speech recognition, including: processing contents metadata to obtain allomorph of target vocabulary required for speech recognition and search; performing speech recognition on speech data uttered by a user to recognize a vocabulary of the speech data; extracting a keyword from the recognized vocabulary; and comparing the keyword with the allomorph of the target vocabulary to extract the contents metadata corresponding to the recognized vocabulary.

In accordance with a third aspect of the present, there is provided an IPTV receiving apparatus using speech recognition, including: a data transceiver for receiving VOD contents and contents metadata in communications with an IPTV contents server; a metadata search apparatus for performing speech recognition on speech data uttered by a user through a speech interface, and comparing a speech-recognized vocabulary with allomorph of target vocabulary to extract a list of VOD contents corresponding to the speech-recognized vocabulary based on the comparison result, wherein the allomorph have been obtained by processing the contents metadata in a form required for speech recognition and search and stored in advance; a controller for requesting the IPTV contents server for any one VOD contents within the list of VOD contents displayed on a screen, wherein the requested VOD contents is received from the IPTV contents server through the data transceiver; and a data output unit for outputting the VOD contents received through the data transceiver under the control of the controller, to display the contents on the screen.

### BRIEF DESCRIPTION OF THE DRAWINGS

The above and other objects and features of the present invention will become apparent from the following description of preferred embodiments, given in conjunction with the accompanying drawings, in which:

FIG. 1 shows a block diagram of an IPTV service system including an IPTV receiving apparatus that employs a metadata search apparatus using a speech interface in accordance with the present invention;

FIG. 2 illustrates a detailed block diagram of the metadata search apparatus in accordance with the present invention;

FIG. 3 provides a flow chart of a metadata processing procedure performed by the metadata search apparatus shown in FIG. 2; and

FIG. 4 shows a flow chart of an IPTV service procedure performed by the IPTV service system including the IPTV receiving apparatus shown in FIG. 1.

### DETAILED DESCRIPTION OF THE EMBODIMENTS

Hereinafter, exemplary embodiments of the present invention will be described in detail with reference to the accompanying drawings.

For a better understanding of the present invention, a user interface, which is widely used in the field of PCs, automobiles, robots, home networks, or the like, employs a multimodal interface technology that combines a speech recognition interface and other interfaces. By applying speech recognition to IPTV services that are dependent on the button control of a remote controller, a user would receive those IPTV services in a more convenient manner, along with the derivation of more various services.

In particular, in VOD service among various contents services, if VOD search is available by speech recognition, the user can receive a desired VOD service through more convenient search. However, in case the user does not recognize a correct VOD title, he or she may make different forms of utterances. If any of those utterances is not registered in the dictionary, the user may not receive a satisfactory service due to its misrecognition. This situation may also occur in searching VOD titles by means of a keypad on the remote controller.

Therefore, in order to handle the above situation, the present invention extracts heterogeneous data of each contents title from contents metadata in advance and then uses them for speech recognition and contents search of data uttered by the user.

According to an IPTV service system and method using a speech interface in accordance with the present invention to be described below, a variety of contents such as information, movies, broadcasting and so on can be provided. The following is an explanation of how to provide contents through VOD services by way of an example.

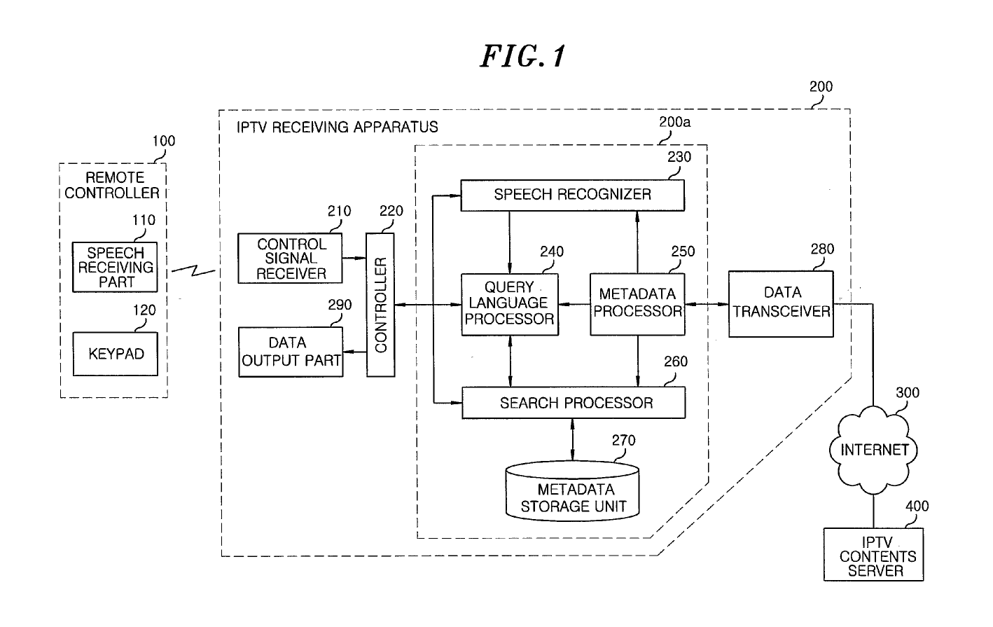

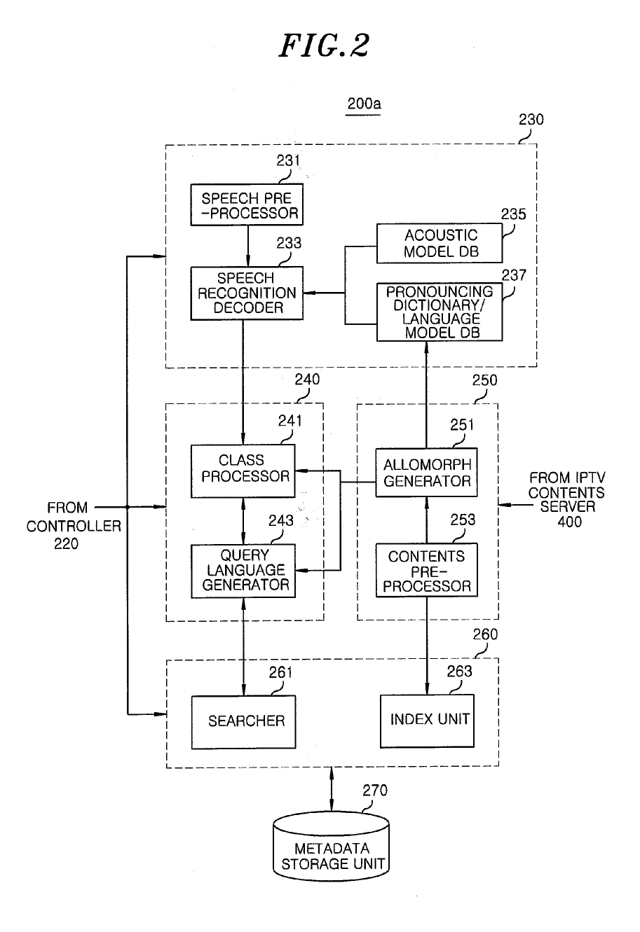

Referring now to FIG. 1, there is illustrated a block diagram of an IPTV service system including an IPTV receiving apparatus that employs a metadata search apparatus using a speech interface in accordance with the present invention, and FIG. 2 shows a detailed block diagram of the metadata search apparatus shown in FIG. 1.

The IPTV service system includes a remote controller 100, an IPTV receiving apparatus 200, and an IPTV contents server 400. The IPTV contents server 400 is connected to the IPTV receiving apparatus 200 via a network such as an Internet 300 and transmits various contents such as information, movies, broadcasting, and so on, or provides additional services.

The remote controller 100 is used to select desired contents, such as a VOD title that a user desires to receive and watch. The remote controller 100 includes a speech receiving part 110 for receiving a contents selection signal by means of an uttered speech from the user, and a keypad 120 for generating a contents selection signal by a selective combination of designated buttons thereon. Such a remote controller 100 transmits various control signals including the contents selection signal for the uttered speech to the IPTV receiving apparatus 200 through an RF or Bluetooth channel, or transmits various control signals including the contents selection signal generated by the manipulation of the keypad to the IPTV receiving apparatus 200 through an RF or Bluetooth channel, like the typical remote controller. The speech receiving part 110 may be implemented with a microphone that converts the uttered input speech into an electrical signal.

The IPTV receiving apparatus 200 includes a control signal receiver 210, a controller 220, a metadata search apparatus 200a, a data transceiver 280, and a data output unit 290. In addition, the metadata search apparatus 200a is constituted by a speech recognizer 230, a query language processor 240, a metadata processor 250, a search processor 260, and a metadata storage unit 270.

The control signal receiver 210 receives the control signals including the content selection signal from the remote controller 100 through the RF or Bluetooth channel and provides the same to the controller 220.

The controller 220 processes various events in response to received signals from the control signal receiver 210, provides an interface environment with the user through graphical user interface (GUI) processing, and performs IPTV control functions by handling control commands and search commands. In response to the control commands handled by the controller 220, the speech recognizer 230, the query language processor 240, the metadata processor 250, and the search processor 260, the data transceiver 280 and the data output unit 290 are activated. Also, when any one contents is selected from a list of contents displayed on a screen (not shown), the controller 220 receives a corresponding selection signal through the control signal receiver 210 and requests the IPTV contents server 400 for contents corresponding to the selection signal, such that the contents corresponding to the selection signal is received from the contents server 400.

The speech recognizer 230 carries out a speech recognition, e.g., by using N-best approach to produce N-best results. The N-best approach is a method in which the result of speech recognition is expressed by several sentences with relatively high probability values. The speech recognizer 230 is composed of a speech pre-processor 231, a speech recognition decoder 233, an acoustic model database (DB) 235, and a pronouncing dictionary/language model DB 237, as shown in FIG. 2.

The speech pre-processor 231 performs pre-processing functions for speech recognition, such as the functions of speech reception, speech detection and extraction of a series of feature vectors.

The acoustic model DB 235 contains statistic models in units (e.g., words, morphemes, or syllables) of speech recognition used for search. The pronouncing dictionary/language model DB 237 contains information on a pronouncing dictionary about each target vocabulary for speech recognition, and information on language models. The pronouncing dictionary/language model DB 237 is operates in conjunction with the metadata processor 250 to be described later and is updated whenever each target vocabulary for speech recognition is changed. That is, the pronouncing dictionary/language model DB 237 is updated based on heterogeneous data provided from the metadata processor 250.

The speech recognition decoder 233 executes the speech recognition on the series of feature vectors of speech from the speech pre-processor 231 by using a search network composed of the acoustic model DB 235 and the pronouncing dictionary/language model DB 237. More specifically, the speech recognition decoder 233 carries out speech recognition by dividing the series of feature vectors in units of speech recognition based on the statistic models, and comparing the series of feature vectors divided in units of speech recognition with the pronouncing dictionary and language model in the pronouncing dictionary/language model DB 237.

On the other hand, the query language processor 240 processes a vocabulary and class information (heterogeneous data of a target VOD title, an actor's name, and a genre name) speech-recognized by the speech recognizer 230 to extract a keyword to be delivered to the search processor 260. As shown in FIG. 2, the query language processor 240 is composed of a class processor 241 and a query language generator 243.

The class processor 241 processes the vocabulary speech-recognized by the speech recognizer 230 and the class information (associated with heterogeneous data of a target VOD title, an actor's name, and a genre name) to generate a class name recognizable by the query language generator 243. The query language generator 243 extracts the keyword available for the search processor 260 from the class name.

When VOD metadata for new VOD contents (with information on a new VOD title and so on) is provided from the IPTV contents server 400 along with an update signal of VOD information, the metadata processor 250 processes the VOD metadata in heterogeneous data required for speech recognition and search and then delivers the same to the speech recognizer 230 and the search processor 260. The metadata processor 250 is composed of a heterogeneous data generator 251 and a contents pre-processor 253.

The contents pre-processor 253 is responsible for pre-processing on the VOD metadata and provides pre-processed VOD metadata to the heterogeneous data generator 251 and an index unit 263. The heterogeneous data generator 251 generates heterogeneous data of the VOD title, and forwards the heterogeneous data to the pronouncing dictionary/language model DB 237.

The search processor 260 performs the function of extracting a list of VOD titles that the user desires from the metadata storage unit 270 by using the keyword provided from the query language processor 240, and the function of receiving the pre-processed VOD metadata for the new VOD contents from the metadata processor 250 and of indexing it in a searchable form. As shown in FIG. 2, the search processor 260 is composed of a searcher 261 and the index unit 263.

The searcher 261 functions to search for the metadata storage unit 270 a VOD list corresponding to the keyword from the query language processor 240. The index unit 263 functions to index metadata for the new VOD contents and store the indexed metadata for the new VOD contents in the metadata storage unit 270. The metadata storage unit 270 contains data on VOD contents being currently serviced in a searchable form.

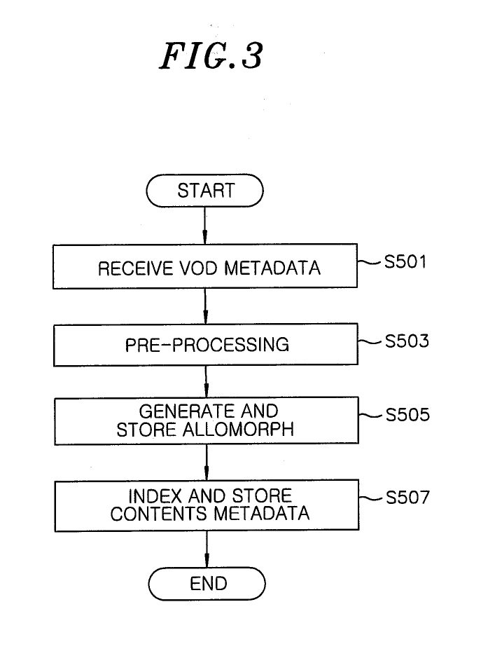

FIG. 3 illustrates a flow chart of a metadata processing procedure performed by the metadata search apparatus shown in FIG. 2.

First, in step S501, when VOD metadata for new VOD contents (with information on new VOD title and so on) is transmitted from the IPTV contents server 400 along with an update signal of VOD information, the data transceiver 280 receives the VOD metadata. The VOD metadata is then provided to the metadata processor 250.

Next, in step S503, the contents pre-processor 253 in the metadata processor 250 pre-processes the VOD metadata to make it available for the IPTV receiving apparatus 200. The VOD metadata so pre-processed is provided to the heterogeneous data generator 251 and also to the index unit 263.

Then, in step S505, the heterogeneous data generator 251 generates heterogeneous data of VOD titles contained in the VOD metadata and delivers the heterogeneous data to the pronouncing dictionary/language model DB 237 in the speech recognizer 230 for their storage. Lastly, in step S507, the index unit 263 indexes metadata for the new VOD contents on a basis of the VOD metadata to store the indexed metadata in the metadata storage unit 270.

In this manner, since the allomorph on the VOD titles has been previously stored in the pronouncing dictionary/language model DB 237 as in step S505, there is no misrecognition on a VOD title during the speech recognition process by the speech recognizer 230 although speeches for the VOD title are uttered inaccurately in case where the user does not correctly recognize the VOD title.

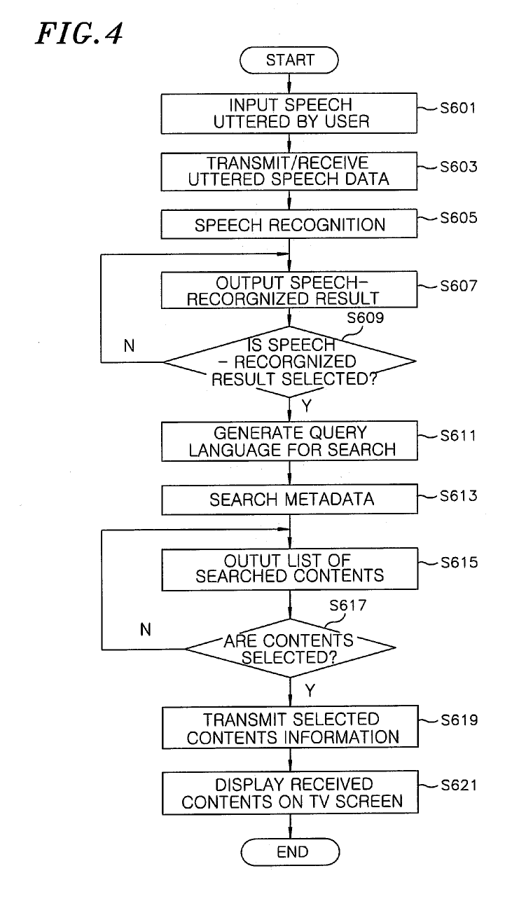

FIG. 4 illustrates a flow chart of an IPTV service procedure performed by the IPTV service system including the IPTV receiving apparatus using a speech interface in accordance with the present invention.

First, the procedure begins with the selection of a designated speech recognition button (not shown) on the keypad 120 of the remote controller 100 when a user wants to search for a desired VOD title, the speech receiving part 110 in the remote controller 100 prepares to receive a speech uttered by the user.

Next, in step S601, when the user utters a desired VOD title, the uttered VOD title is received by the speech receiving part 110. In a subsequent step S603, the remote controller 100 generates uttered data corresponding to the user's speech and the uttered data is then transmitted to the IPTV receiving apparatus 200. Then, the control signal receiver 210 in the IPTV receiving apparatus 200 receives the uttered data from the remote controller 100 and forwards it to the controller 220.

The controller 230 delivers the uttered data to the speech recognizer 230 and instructs the speech recognizer 230 to perform a speech recognition process on the uttered data. The speech pre-processor 231 extracts a series of feature vectors from the uttered data and provides the same to the speech recognition decoder 233.

Then, in step S605, the speech recognition decoder 233 in the speech recognizer 230 performs speech recognition on the series of feature vectors through a search network composed of the acoustic model DB 235 and the pronouncing dictionary/language model DB 237. The result of speech recognition made by the speech recognizer 230, that is, N-best results, are provided to the controller 220 and the query language processor 240. Then, in step S607, the controller 220 controls the data output unit 290 to display the N-best results on a screen of TV.

If the N-best results are provided on the TV screen in this way, the user selects one of N-best results corresponding to the contents he or she uttered out by clicking a designated button on the remote controller 100 in step S609. Such a selection is then delivered to the query language processor 240 through the control signal receiver 210 and the controller 220.

The class processor 241 in the query language processor 240 processes recognized vocabulary of the N-best result selected by the user, that is, speech-recognized vocabulary and its class information to generate a class name recognizable by the query language generator 243, and provides the class name to the query language generator 243. Then, in step S611, the query language generator 243 extracts, from the class name, a keyword suitable for the search processor 260 to input to the search engine in step S611. The keyword so extracted is then delivered to the search processor 260.

Next, in step S613, the search processor 260 compares the keyword from the query language processor 240 with the indexed metadata stored in the metadata storage unit 270 to extract a list of VOD contents associated with the keyword, and forwards the list of VOD contents to the controller 220.

Subsequently, in step S615, the controller 220 controls the data output unit 290 to display the list of VOD contents on the TV screen.

In this manner, if the list of VOD contents is displayed on the TV screen, the user selects one of the VOD contents in the list he or she wants to receive and watch by clicking a designated button on the remote controller 100 in step S617. Information on the selected VOD contents is then delivered to the controller 230 via the control signal receiver 210.

Thereafter, in step S619, the controller 220 provides the IPTV contents server 400 with the VOD contents information selected by the user.

Lastly, in step S621, the IPTV contents server 400 transmits, to the IPTV receiving apparatus 200, VOD contents corresponding to the VOD contents information selected by the user, so that the IPTV receiving apparatus 200 displays the corresponding VOD contents on the TV screen through the data output unit 290. Thus, the user can watch the desired VOD contents through the TV screen.

In accordance with the present invention, a user can receive more convenient contents services using the IPTV search service using a speech interface, compared with the existing VOD content services that are dependent on the button control of the remote controller.

In addition, the prior art method does not allow a user to receive a satisfactory service due to misrecognition if there is any utterance unregistered in the dictionary, among different forms of utterances which may be made in case where the user does not recognize a correct contents title, or upon occurrence of the same case in contents search by a keypad input. On the other hand, the present invention can solve the above problem by extracting allomorph of each contents title from contents metadata in advance and using them for search and speech recognition. That is, in accordance with the present invention, the user can receive search and watching services about desired contents, even for various forms of speeches uttered by the user, providing IPTV services through the functions of speech recognition, information search, and allomorph generation provided by a set-top box.

While the invention has been shown and described with respect to the preferred embodiments, it will be understood by those skilled in the art that various changes and modification may be made without departing from the scope of the invention as defined in the following claims.

What is claimed is:

1. A metadata search apparatus using speech recognition, comprising:
a metadata processor for processing contents metadata to obtain allomorph of target vocabulary required for speech recognition and search;
a metadata storage unit for storing the contents metadata; a speech recognizer for performing speech recognition on speech data uttered by a user by searching the allomorph of the target vocabulary;
a query language processor for extracting a keyword from the vocabulary speech-recognized by the speech recognizer; and
a search processor for searching the metadata storage unit to extract the contents metadata corresponding to the keyword.

2. The apparatus of claim 1, wherein the metadata processor includes:
a allomorph generator for generating the allomorph for the search of the speech recognizer; and
a contents pre-processor for pre-processing the contents metadata in a form that can be processed by the allomorph generator and providing pre-processed contents metadata to the allomorph generator.

3. The apparatus of claim 1, wherein the speech recognizer includes:
a speech pre-processor for extracting a series of feature vectors from the uttered speech data;
an acoustic model database that stores statistic models in units of speech recognition to be used for search;
a pronouncing dictionary/language model database that stores information on pronouncing dictionary/language model for each target vocabulary for speech recognition; and
a speech recognition decoder for dividing the series of feature vectors in units of speech recognition based on the statistic models, and comparing the series of feature vectors divided in units of speech recognition with the pronouncing dictionary/language model for speech recognition.

4. The apparatus of claim 3, wherein the pronouncing dictionary/language model database is updated based on the allomorph.

5. The apparatus of claim 1, wherein the query language processor includes:
a query language generator for extracting the keyword available for the speech processor; and
a class processor for generating a class name recognizable by the query language generator from the speech-recognized vocabulary to provide the class name to the query language generator.

6. The apparatus of claim 1, wherein the search processor includes:
an index unit for indexing the contents metadata and storing an indexed contents metadata in the metadata storage unit; and
a searcher for extracting a contents list corresponding to the speech-recognized vocabulary from the metadata storage unit by using the keyword.

7. A metadata search method using speech recognition, comprising:
processing contents metadata to obtain allomorph of target vocabulary required for speech recognition and search;
performing speech recognition on speech data uttered by a user to recognize a vocabulary of the speech data;
extracting a keyword from the recognized vocabulary; and
comparing the keyword with the allomorph of the target vocabulary to extract the contents metadata corresponding to the recognized vocabulary.

8. The method of claim 7, further comprising:
indexing the allomorph; and
storing the indexed allomorph.

9. The method of claim 7, wherein said performing speech recognition includes:
extracting a series of feature vectors from the uttered speech data; and
dividing the series of feature vectors in units of speech recognition; and
comparing the series of feature vectors divided in units of speech recognition with a pronouncing dictionary/language model to recognize it as the recognized vocabulary.

10. The method of claim 9, wherein the pronouncing dictionary/language model is updated based on the allomorph.

11. The method of claim 7, wherein said extracting a keyword from the recognized vocabulary includes:
generating a class name from the recognized vocabulary; and
extracting the keyword from class name.

12. The method of claim 9, wherein said comparing the keyword with the allomorph of the target vocabulary includes:
extracting a VOD contents corresponding to the recognized vocabulary based on the comparison result.

13. An IPTV receiving apparatus using speech recognition, comprising:
a data transceiver for receiving VOD contents and contents metadata in communications with an IPTV contents server;
a metadata search apparatus for performing speech recognition on speech data uttered by a user through a speech interface, and comparing a speech-recognized vocabulary with allomorph of target vocabulary to extract a list of VOD contents corresponding to the speech-recognized vocabulary based on the comparison result, wherein the allomorph have been obtained by processing the contents metadata in a form required for speech recognition and search and stored in advance;
a controller for requesting the IPTV contents server for any one VOD contents within the list of VOD contents displayed on a screen, wherein the requested VOD contents is received from the IPTV contents server through the data transceiver; and
a data output unit for outputting the VOD contents received through the data transceiver under the control of the controller, to display the contents on the screen.

14. The IPTV receiving apparatus of claim 13, further comprising a control signal receiver for receiving a remote control signal and the uttered speech data.

15. The IPTV receiving apparatus of claim 13, wherein the metadata search apparatus includes:
a metadata processor for processing the contents metadata to obtain the allomorph;
a metadata storage unit for storing the contents metadata;
a speech recognizer for performing speech recognition on the uttered speech data by searching the allomorph of the target vocabulary;
a query language processor for extracting a keyword from the speech-recognized vocabulary; and
a search processor for searching the metadata storage unit to extract the contents metadata corresponding to the keyword.

16. The IPTV receiving apparatus of claim 15, wherein the metadata processor includes:
a allomorph generator for generating the allomorph to provide the allomorph to the speech recognizer; and
a contents pre-processor for pre-processing the contents metadata in a form that can be processed by the allomorph generator and providing pre-processed contents metadata to the allomorph generator.

17. The IPTV receiving apparatus of claim 15, wherein the speech recognizer includes:
a speech pre-processor for extracting a series of feature vectors from the uttered speech data;
an acoustic model database that stores statistic models in units of speech recognition to be used for search;
a pronouncing dictionary/language model database that stores information on pronouncing dictionary/language model for each target vocabulary for speech recognition; and
a speech recognition decoder for dividing the series of feature vectors in units of speech recognition based on the statistical models, and comparing the series of feature vectors divided in units of speech recognition with the pronouncing dictionary/language model for speech recognition.

18. The IPTV receiving apparatus of claim 17, wherein the pronouncing dictionary/language model database is updated based on the allomorph.

19. The IPTV receiving apparatus of claim 15, wherein the query language processor includes:
a query language generator for extracting the keyword available for the speech processor; and
a class processor for generating a class name recognizable by the query language generator from the speech-recognized vocabulary to provide the class name to the query language generator.

20. The IPTV receiving apparatus of claim 15, wherein the search processor includes:
an index unit for indexing the contents metadata and storing an indexed contents metadata in the metadata storage unit; and
a searcher for extracting a VOD contents corresponding to the speech-recognized vocabulary from the metadata storage unit by using the keyword.
